(19) United States
(12) Patent Application Publication
(10) Pub. No.: US 2007/0095940 A1
(43) Pub. Date: May 3, 2007

(54) Fluid product dispensing head

(75) Inventors: Stephane Beranger, Le Neubourg (FR); Firmin Garcia, Evreux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S, Le Neubourg (FR)

(21) Appl. No.: 10/563,907

(22) PCT Filed: Jul. 8, 2004
(86) PCT No.: PCT/FR04/01789

§ 371 Date: Jul. 10, 2006

(30) Foreign Application Priority Data
Jul. 10, 2003 (FR) 03/08490

(51) Int. Cl. A62C 11/00

(52) U.S. Cl. 239/333; 239/337; 239/600

(57) ABSTRACT

The invention concerns a fluid product dispensing head designed to be mounted on a fluid product dispensing member, said head comprising: a body (1) defining a dispensing channel (13) having a substantially axial inlet (131), open downwards and designed to be connected to the dispensing member, and a lateral outlet (132) emerging onto an outer peripheral surface (15) of the body; and an outer ring (2) defining a dispensing orifice (23), the body being mounted in the ring such that the lateral outlet (132) of the channel (13) communicates with the dispensing orifice (23). The invention is characterized in that the ring (2) comprises stop means (26, 27), the body defining a support surface (17) in abutting contact with the stop means, the body being insertible from the top into the ring.

This present invention concerns a fluid-product dispensing head intended to be fitted to a fluid product dispensing device, said head including a body forming a dispensing channel with an inlet that is substantially axial, opening downwards and intended to be connected to the dispensing device, and a lateral outlet opening onto a external peripheral area of the body, with an external crown forming a dispensing orifice, the body being mounted in the crown so that the lateral outlet of the channel communicates with the dispensing orifice. Such a dispensing head can, for example, be used in the fields of the perfumery, cosmetics or pharmacy, amongst others.

Document FR-2 793 779 describes a dispensing head of this type. The crown is fitted to the body from above, or alternatively, the body is set into the crown from below. This does not guarantee a high attachment quality, since a vertical press applied from top to bottom on the body results in separation of the crown. Now in this type of dispensing head, which frequently comes in the form of a push-button device, the user applies pressure from top to bottom to activate the dispensing device on which the dispensing head is mounted.

The goal of this present invention is to overcome this disadvantage in previous designs by creating a dispensing head whose attachment between the crown and the body is more reliable.

In order to attain this goal, the present invention proposes that the crown should include abutment means, the body forming a bearing surface in abutted contact with the abutment means, the body being suitable for axial insertion from above into the crown. Advantageously, the abutment means include an abutment rim onto which the bearing surface presses, said rim forming an abutting zone facing substantially upwards, while the bearing surface is oriented substantially downwards. Preferably, the crown includes a cylindrical internal wall in sealed contact with the external peripheral area of the body, the abutment means being located at the lower or upper edge of this cylindrical internal wall.

In another aspect of the invention, the dispensing head includes swirling means formed upstream of the dispensing orifice.

In addition, the dispensing head can also include a covering band in which the crown and the body are mounted. Advantageously, the band includes an substantially cylindrical skirt pierced with a lateral opening, and an upper wall closing off the skirt at its upper end, with the crown including an external wall at which the dispensing orifice opens, the crown being positioned within the band with the dispensing orifice positioned to face the lateral opening. Advantageously, the band includes means for locking the crown and the body inside the band. According to one form of implementation, the external wall of the crown is in tightly locked onto the skirt of the band. Additionally or alternatively, the locking means can include at least one locking profile formed within the skirt, with the crown latching onto the said “at least one locking profile” so as to prevent any movement of the crown out of the band, the body thus being locked between the crown and the upper wall of the band. According to one practical form of implementation, the skirt includes a lower edge folded inwards, the said edge forming a locking extremity oriented upwards in the direction of the upper wall.

Thus the body, inserted into the crown from above, is trapped between the band and the crown, which is itself locked within the band. A dispensing head is thus created that cannot be dismantled, since all the parts lock each other in position. This would not be the case with the dispensing head of the aforementioned document describing previous designs.

The invention will now be described more fully, with reference to the drawings, and giving two methods of implementation of the invention, by way of non-limited examples.

In the figures:

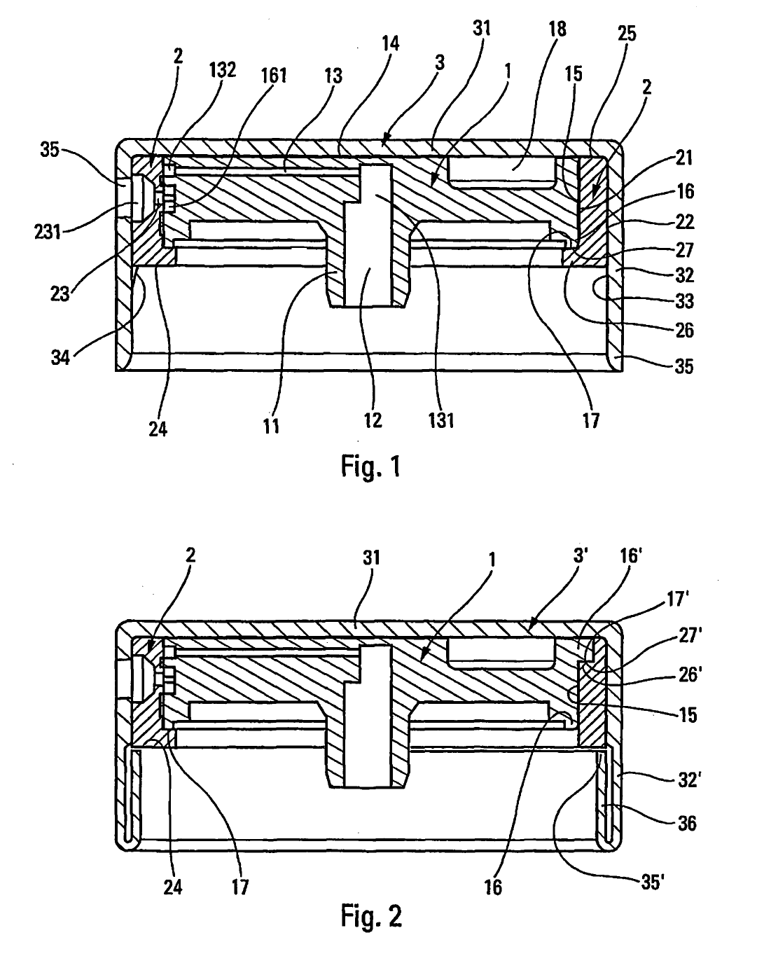

FIG. 1 is a view in vertical cross section through a dispensing head according to a first method of implementation of the invention, and

FIG. 2 is a view similar to that of FIG. 1, for a second method of implementation of the invention.

In both methods of implementation, the dispensing head is a head of the push-button device type, on which one presses in order to activate an under-lying dispensing device such as a pump or a valve. The dispensing head is intended to be fitted to the upper end of an operating and return rod which forms part of the dispensing device. The dispensing device and its associated dispensing head can be mounted on or in an opening formed by a fluid-product reservoir. However, a dispensing head according to the invention can also be used for the single function of dispensing, without being associated with a push-button function. In other words, the push-button employed to activate the dispensing device can be dissociated from the dispensing head.

In both methods of implementation, the dispensing head includes a body 1, a crown 2 and a covering band 3. The covering band is optional but advantageous, particularly in the case where the dispensing head takes the form of a push-button device. The body 1 and the crown 2 can be made from a plastic material, while the covering band can be made from a plastic material or from metal. The covering band 3 conventionally has no function other than an aesthetic one, and is used to hide the plastic structure, not always perfect, of the body and the crown.

In FIG. 1, the body 1 includes a connecting sleeve 11 which extends downwards. The connecting sleeve 11 is open downwards and forms within it a housing 12 designed to receive the upper end of an operating and return rod forming part of a dispensing device such as a pump or a valve. This housing 12 is extended upwards by an axial inlet 131. This inlet 131 is extended radially to form a dispensing channel 13 which opens, forming a radial lateral outlet 132 at the level of an external peripheral area 15 of the body 1. The connecting sleeve 11 occupies a position that is substantially central and axial, while the dispensing channel 13 extends radially from the axial centre to the external periphery of the body. The external peripheral area 15 is formed with several channels or recesses at the level of the outlet 132 of the dispensing channel 13. These channels and recesses form swirl channels as well as a central swirl chamber 161. These channels and this chamber can be formed only or partially by the body 1. The body 1 also includes an upper surface 14, which here is substantially flat, but formed with a recess 18 which can act as an orientation interlock when attaching the body 1. The body 1 forms a lower surface, opposite to the middle of which extends the connecting sleeve 11. In addition, directly below the external peripheral area 15, the lower surface forms an abutting edge 16 which forms a bearing surface facing downwards. This bearing surface 17 can be continued over all of the periphery of the edge 16, or can be formed by separate segments. Although this bearing surface may be formed directly below the external peripheral area 15, this bearing surface can also be placed at a different position on the lower surface of the body 1. This is the FIG. 1 case.

The crown 2 includes an substantially cylindrical internal wall 21, an substantially cylindrical external wall 22, an upper annular wall 25 and a lower annular wall 24. The internal wall 21 is perfectly cylindrical over most of its height from the upper wall 25. On the other hand, at its lower end, the internal wall 21 forms an abutment rim 26 forming an abutment zone 27 facing upwards. This abutment zone 27, like the abutment surface 17, does not need to be flat. In fact, the zone 27 and the surface 17 can be inclined. It is possible, for example, to have an abutted contact of the cone-to-cone type. However, the internal wall 21 is pierced with a dispensing orifice 23 which lies on the side of the external wall 22 in the form of a transmission cone 231. The dispensing orifice 23 is perfectly centred on the swirl chamber 161. According to the invention, the swirl chamber and its associated swirl channels form swirling means, formed jointly by the body 1 and the crown 2. The channels and/or the swirl chamber can be formed jointly by the crown and the body or by either of them. It can be seen easily that the final mounting position of the body 1 in the crown 2 is achieved when the bearing surface 17 presses onto the abutment zone 27. Of course, it is necessary that the external peripheral area 15 makes a sealed contact with the internal wall 21, particularly at the point where the dispensing channel 13 opens out, and also at the swirl channels and the swirl chamber. Given that the abutment zone 27 is facing generally upwards while the bearing surface 17 is facing generally downwards, the insertion or the mounting of the body 1 in the crown 2 is effected by engaging the body axially in the crown 2 from above.

Holding the crown 2 firmly, the body 1 should be inserted axially from top to bottom into the crown 2. Orientation of the body 1 in the crown 2 is necessary in order to centre the dispensing orifice 23 on the swirl chamber 161. This orientation can be effected by means of the recess 18 and the dispensing cone 231.

A dispensing head of the invention can be composed of only two component parts, namely the crown and the body. Nevertheless, according to the invention, the dispensing head can also include a covering band 3 into which the assembly formed by the body and the crown are inserted. In the method of implementation of FIG. 1, the covering band 3 includes an upper wall 31 which acts as push surface on which a user applies one or more finger(s) to put pressure on the dispensing head, and thus to operate the under-lying dispensing device. The covering band 3 also includes a cylindrical skirt 32 which extends downwards from the external periphery of the upper wall 31. This skirt 32 has a free annular lower end 34. The skirt is advantageously pierced with an opening 35 which must be centred on the dispensing orifice 23. The skirt 32 includes an substantially cylindrical internal wall 33. The inside diameter of this internal wall 33 is substantially equal to or slightly below the outside diameter of the crown 2. Thus, the assembly formed by the crown and the body can be inserted by force into the covering band so as to create a clamping radial contact between the external wall 22 of the crown 2 and the internal wall 33 of the band 3. This radial clamping locks the assembly formed by the crown and the body 1 within the band 3. It should be noted that locking the crown 2 in the band 3 involves locking or trapping of the body 1 between the crown 2 and the upper wall 31 of the band 3, given that the body 1 is inserted into the crown 2 from above. In order to improve the retention of the crown 2 in the band 3, it is possible to provide any locking means, such as small notches 34 formed on or by the internal wall 33 of the band 3. These small notches 34 have a slight slope followed by sharp edge in the manner of a harpoon. Insertion of the crown 2 in the band 3 is possible due to the slight slope, and after passing the small notches 34, the lower wall 24 of the crown 2 takes up a position just to above the sharp edge of the small notches 34. Thus, the crown 2 is definitively locked within the band 3. These small locking notches 34 are optional, and definitive attachment can be effected by the radial clamping of the crown 2 in the band 3 alone.

Referring now to FIG. 2, which shows an alternative embodiment, in which (the covering band 3′ is different from the covering band 3 of FIG. 1), and the body 1 and the crown 2 are slightly different from those of FIG. 1. Nevertheless, the crown is able to form a shoulder 26′ at the upper end of the internal wall 21. This shoulder also lies on the upper wall 25. This shoulder forms an abutment area 27′ which is facing generally upwards, like abutment surface 27. In addition, the body is able to form a continuous collar or discrete flanges 16′ which lie radially on the outside of the external surface 15. This collar or these flanges form a bearing surface 17′ facing generally downwards, like bearing surface 17. This abutment area 27′ can be implemented with or without abutment area 27 and pressing area 17. In FIG. 2, the rim 26 is partially eliminated, but still remains alongside the dispensing orifice. In addition, the shoulder 16′ is not formed at the orifice. In any event, these surfaces 27′ and 17′ have the same function as surfaces 27 and 17, namely to limit the axial engagement of the body in the crown from above. Likewise, the cylindrical skirt 32′ of the band 3′ is formed here with an inside folded or lipped part 36, so that the end 35′ of the skirt is facing upwards. Advantageously, this end 35′ is located just below the lower wall 24 of the crown. This end 35′ has the effect of locking the crown 2 in the band 3. To allow the passage of the crown 2 inside the band 3 the skirt has a smaller wall thickness at the lipped part 36. A small space is left between the skirt 32′ and its folded part 36 so that the folded part 36 can deform elastically and radially outwards during the passage of the crown 2. When the crown 2 has reached its final position above the end 35′, the folded part 36 can again shrink radially inwards, to definitively lock the crown in the band 3′. Here again, the crown 2 is locked in the band 3′, definitively trapping the body 1 between the crown 2 and the upper wall 31 of the band 3′.

By means of the invention, a dispensing head is created in two or three parts, which is particularly solid an able to withstand very high pressures.

1. A fluid-product dispensing head intended to be fitted to a fluid product dispensing device, said head including:
a body (1) forming a dispensing channel (13) having a substantially axial inlet (131), open downwards and intended to be connected to the dispensing device, and a lateral outlet (132) opening onto an external peripheral area (15) of the body, and
an external crown (2) forming a dispensing orifice (23), the body being mounted in the crown so that the lateral outlet (132) of the channel (13) communicates with the dispensing orifice (23),
characterised in that the crown (2) includes abutment means (26, 27), with the body forming a bearing surface (17) in abutted contact with the abutment means, the body being capable of axial insertion into the crown from above.

2. A dispensing head according to claim 1, in which the abutment means include an abutment rim (26) on which the bearing surface (17) presses, said rim forming an abutment zone (27) facing substantially upwards, while the bearing surface (17) is oriented substantially downwards.

3. A dispensing head according to claim 1, in which the crown (2) includes a cylindrical internal wall (21) in sealed contact with the external peripheral area (15) of the body, the abutment means (26, 27) being located at the lower or upper edge of this cylindrical internal wall (15).

4. A dispensing head according to claim 1, including swirling means (161, 162) formed upstream of the dispensing orifice (23).

5. A dispensing head according to claim 1, also including a covering band (3, 3′) in which the crown (2) and the body (1) are mounted.

6. A dispensing head according to claim 5, in which the band (3, 3′) includes a substantially cylindrical skirt (32, 32′) pierced with a lateral opening (35) and an upper wall (31) closing off the skirt at its upper end, where the crown (2) includes an external wall (22) at which the dispensing orifice (23) emerges, the crown being located in the band with the dispensing orifice positioned facing the lateral opening.

7. A dispensing head according to claim 6, in which the band includes means (34, 35′) for locking the crown and the body within the band.

8. A dispensing head according to claim 7, in which the external wall (22) of the crown (2) is tightly locked onto the skirt (32, 32′) of the band.

9. A dispensing head according to claim 7, in which the locking means include at least one locking profile (34, 35′) formed within the skirt, the crown engaging said at least one locking profile so as to prevent extraction of the crown from the band, the body thus being locked between the crown and the upper wall (31) of the band.

10. A dispensing head according to claim 8, in which the skirt (32′) includes a lower edge (36) folded inwards, said edge forming a locking extremity (35′) oriented upwards in direction of the upper wall (31).
